(19) United States
(12) Patent Application Publication
(10) Pub. No.: US 2006/0289288 A1
(43) Pub. Date: Dec. 28, 2006

(54) Distillation unit and a method of distillation

(76) Inventors: John Barry Finn, Lisarow, New South Wales (AU); Brian Douglas Jenkins, Wyong, New South Wales (AU)

Correspondence Address: INTELLECTUAL PROPERTY LAW OFFICE OF JOEL VOELZKE, 400 CORPORATE POINTE, SUITE 300, CULVER CITY, CA, 90230, US

(21) Appl. No.: 10/534,222

(22) PCT Filed: Nov. 10, 2003
(86) PCT No.: PCT/AU03/01480

§ 371 Date: Aug. 23, 2006

(30) Foreign Application Priority Data
Nov. 8, 2002 (AU) 2002-952560
Jan. 28, 2003 (AU) 2003-900340
May 19, 2003 (AU) 2003-902401
Jul. 30, 2003 (AU) 2003-903947

(51) Int. Cl. B01D 3/00; B01D 3/42

(52) U.S. Cl. 202/200; 202/202; 202/181

(57) ABSTRACT

A distillation unit (1) includes a container in the form of a generally cylindrical steel pot (2) for receiving a first liquid (3). The liquid is evaporated following application of heat from a heat source (4) to form a liquid vapour. Pot (2) has an upwardly facing generally circular opening (5) defined by a peripheral edge in the form of a continuous annular lip (6). A heat exchanger in the form of a generally circular stainless steel dish (9) engages substantially all of lip (6) and extends across substantially all of opening (5). Dish (9) has a downwardly facing substantially frusto-conical condensation surface (10) both for condensing the liquid vapour that contacts surface (10) and for directing the condensate inwardly from lip (6) to a central collection zone (11) that is a substantially planar and horizontal surface. A collector in the form of a metal drinking cup (12) is disposed within pot (2) for receiving the condensate.

### FIELD OF THE INVENTION

The present invention relates to distillation and in particular to a distillation unit and a method of distillation.

The invention has been developed primarily for the low-pressure distillation of water for domestic consumption and will be described hereinafter with reference to that application. However, the invention is not limited to that particular field of use and is suitable for distilling salt water, river water, and other water, whether for domestic use, medical use, scientific use, or the like.

### BACKGROUND

Any discussion of the prior art throughout the specification should in no way be considered as an admission that such prior art is widely known or forms part of common general knowledge in the field.

A number of methodologies have been developed to improve the quality of water for domestic consumption. While some of those involve the centralised treatment of the water prior to distribution, there has been a move by consumers to adopt additional measures at the domestic site immediately prior to delivery. On such measure is water filtration, which is relatively popular and cost effective for providing low volumes of drinking water for domestic use. However, there is an inherent compromise between cost, production rates and the purity of the water that is delivered, and the fact that this can vary considerably over the lifetime of the filter elements. The cost is also affected by the frequency with which the filter elements have to be replaced or cleaned.

Another measure is the distillation of water for domestic consumption, which is typically by way of a single stage distillation unit that is mounted to a bench top or other horizontal surface. One such unit is manually operable by placing about 4 litres of water in a heating chamber. After about 4 hours the water will be available for consumption. Another unit is mounted typically under a bench and is cooled both to allow under-bench placement, and also to increase throughput. The cooling system is connected to a domestic water supply, and consumes about 7 to 8 times the amount of distilled water produced.

Accordingly, the distillation of water for domestic consumption is not widespread due primarily to a relatively low yield or throughput and a relatively high level of energy or resource consumption to gain that throughput.

In larger scale applications, such as laboratories, hospitals, and industrial sites, where far greater throughputs are required, use is made of multi-stage distillation units. These units are much more expensive to purchase and maintain, as they are generally pressurised and make use of superheated steam. That is, the higher operating pressures require the units to be engineered robustly, not only for operation, but also to tolerate likely fault conditions. The cost factor alone is often enough to prevent the application of these devices to domestic sites, but so too is the need for skilled operators for such units. Other factors are that these units consume large amounts of energy, generate considerable heat, and need to be cooled, making them ill suited to the typical space restrictions that arise in domestic installations. Moreover, to gain the full advantage of such an industrial unit, there is need to utilise it at full capacity. However, this would require lots of storage space for the distilled water given the considerable time variance of the demand that is called for in a domestic application.

### SUMMARY OF THE INVENTION

It is an object of the present invention to overcome or ameliorate at least one of the disadvantages of the prior art, or to provide a useful alternative.

According to a first aspect of the invention there is provided a distillation unit including:

a container for receiving a first liquid wherein the liquid is evaporated to form a liquid vapour, the container having an upwardly facing opening defined by a peripheral edge;

a heat exchanger for engaging the edge and extending across at least substantially all the opening, the exchanger having a downwardly facing condensation surface both for condensing the liquid vapour that contacts that surface and for directing the condensate inwardly from the edge to a collection zone; and

a collector being disposed within the container for receiving the condensate.

In an embodiment, the condensation surface is inclined inwardly from at least some of the edge. More preferably, the condensation surface is inclined inwardly from substantially all of the edge and terminates at the collection zone. Even more preferably, the collection zone is centrally disposed and the condensation surface is conical. In some embodiments, the condensation surface is frusto-conical and the collection zone is defied by a substantially planar circular collection surface. In other embodiments, the condensation surface is pyramidal, and preferably truncated pyramidal.

Preferably, in use, the downwardly filing condensation surface is inclined with respect to the horizontal by between 10° and 50°. More preferably, the condensation surface is inclined with respect to the horizontal by between 15° and 35°. Even more preferably, the condensation surface is inclined with respect to the horizontal by between 20° and 30°.

In an embodiment, the exchanger engages with the edge to substantially seal the opening. Preferably, the heat exchanger is gravitationally biased into engagement with the edge. In other embodiments, however, the heat exchanger is secured into engagement with the edge by one or more of a: clamp; screw, bolt; rivet; belt; clasp; adhesive; or the like. More preferably, the heat exchanger is releaseably secured into engagement with the edge.

In an embodiment, the edge lies substantially in a plane, and preferably a substantially horizontal plane.

In an embodiment, the collection zone is centrally disposed with respect to the condensation surface. Preferably, the collection surface, in use, is inclined with respect to the condensation surface such that the condensate, upon contacting the collection surface, preferentially falls from the heat exchanger and into the collector. In an embodiment, the collection zone includes a plurality of collection surfaces. Moreover, while some embodiments make use of a substantially planar collection space, other embodiments make use of one or more non-planar collection surfaces.

In an embodiment, the heat exchanger includes an exchanger body having an outer surface of which at least a portion defines the collection surface and an inner surface for engaging with a heat exchanging fluid. Preferably, the exchanger body is a receptacle for the heat exchanging fluid. More preferably, the exchanger body includes at least one sidewall, and the inner surface and the outer surface are opposites faces of that at least one sidewall. Even more preferably, the at least one sidewall is constructed from a metal. In some embodiments the metal is steel, and preferably stainless steel, while in other embodiments, use is made of aluminium, other metals, their alloys, or a combination. In an embodiment, the at least one sidewall is constructed from 316 grade stainless steel.

In an embodiment, the container includes a container base, and at least one container sidewall extending upwardly from the container base and terminating in the edge.

Preferably, the collector includes a collector base, and at least one collector sidewall extending upwardly from the collector base for defining the collector opening. More preferably, the collector base is spaced apart from the container base. Even more preferably, the collector base is spaced apart from the first liquid. In an embodiment, the collector sidewall includes, adjacent to the collector opening, an overflow for returning excess collected condensate to the container.

In an embodiment the collector includes a collector opening through which the condensate enters the collector. More preferably, the collector opening is upwardly facing and extends horizontally beyond the collection surface. Preferably, the collection surface and the collector opening are both substantially circular and, in use, substantially coaxial. In some embodiments, the collection surface lies above the collector opening, while in other embodiments, the condensation surface extends through the collector opening such that the collection surface lies below the collector opening.

In an embodiment the collector includes a collector body having a lid in which the collector opening is formed. Preferably, the lid is releaseably mounted to the collector body. However, in other embodiments, the lid is fixedly mounted to the collector body. In still further embodiments, the lid is integrally formed with the collector body. In an embodiment the lid includes a first zone surrounding the collector opening and a second zone surrounding the first zone, wherein condensate contacting the first zone is progressed toward the collector opening and condensation contacting the second zone is directed away from the collector opening. Preferably, the collector opening is substantially circular, the first and second zones are substantially annular, and the collector aping and the first and second zones are substantially concentric. More preferably, the first zone, in use, underlies and extends horizontally beyond the collection zone.

In an embodiment, the collector includes a fitter for filtering the condensate that enters the collector. Preferably, the filter is disposed within the collector. In other embodiments, however, the filter is disposed external to the collector for filtering the condensate is it is removed from the collector. In an embodiment, the filter is an activated carbon filter. However, in other embodiments, use is made of other filters.

In an embodiment the collector, in use, retains at least about 0.5 litres of condensate. In another embodiment, the collector, in use, retains at least about 1 litre of condensate. In a further embodiment the collector, in use, retains greater than about 1 litre of condensate.

In an embodiment, the first liquid is metered into the container. Preferably, container includes a valve for metering the first liquid into the container, wherein the valve connects the container with a source of the liquid. More preferably, the value is responsive to the level of the first liquid within the container for metering the first fluid. Even more preferably, the valve is a float valve.

According to a second aspect of the invention there is provided a distillation unit for a container having an upwardly facing opening defined by a peripheral edge and a collector this is disposed within the container, wherein the container receives a first liquid that is evaporated to form a liquid vapour and the unit includes:

a downwardly facing condensation surface for engaging the edge and extending across at least substantially all the opening to both condense the liquid vapour that contacts the condensation surface and to direct the condensate inwardly from the edge toward the collector; and

a heat exchanging surface for engaging with a heat exchange medium and which is in thermal contact with the condensation surface.

In an embodiment, the unit includes an exchanger body having a first sidewall with opposite inner and outer surfaces that respectively define the heat exchanging surface and the condensation surface. Preferably, the exchanger body includes a plurality of sidewalls that define a cavity having an upper region and a lower region, wherein the first sidewall is disposed within the lower region. More preferably, the cavity contains a predetermined quantity of the medium, wherein the medium is circulated between the cavity and an external heat exchanger. In an embodiment, the exchanger body includes an exchanger inlet for directing the medium toward the lower region, and an exchanger outlet for drawing the medium from the upper region. Preferably, the exchanger inlet directs the medium toward to first sidewall.

In an embodiment, the circulation is continuous. However, in other embodiments, the circulation is dependent upon a temperature of to medium. Preferably, the temperature is that of the medium within the cavity.

In an embodiment, the external heat exchanger includes a reservoir for receiving the medium from the cavity, and a pump for directing the medium from the reservoir to the cavity. In an embodiment, the reservoir has an upper portion and a lower portion, wherein the pump directs the medium from the lower portion to the inlet and the reservoir receives the medium from the cavity into the upper portion.

In an embodiment, the reservoir is disposed below the cavity.

In an embodiment, the external heat exchanger includes a heat exchanging path trough which the medium progresses between the cavity and the reservoir. Preferably, the heat exchanging path includes a fluid-to-air radiator. More preferably, the medium is water and the radiator is a water-to-air radiator. Even more preferably, in use, the radiator is disposed below the uppermost part of the cavity and above the uppermost level of the medium in the reservoir.

In an embodiment the pump operates to maintain the medium with the cavity at a temperature of less than about 90° C. In another embodiment, the pump operates to maintain the medium with the cavity at a temperature of less than about 85° C. In another embodiment, the pump operates to maintain the medium with the cavity at a temperature of less than about 70° C. In another embodiment, the pump operates to maintain the medium with the cavity at a temperature of less than about 60° C. In an embodiment the pump operates continuously. However, in other embodiments the pump operates intermittently or periodically. In some embodiments, the external heat exchanger includes a controller that is responsive to the temperature of the medium at one or more spaced apart locations for selectively operating the pump.

In an embodiment, in use, the cavity contains about 5 litres of the medium. However, in another embodiment, the cavity contains about 7 litres of the medium. In other embodiments, the cavity contains less than about 5 litres of the medium, while in other embodiments, the cavity contains greater than about 7 litres of the medium.

In an embodiment, the container receives up to a maximum volume of the first fluid and the cavity contains a predetermined volume of the medium, the predetermined volume being at least about 10% of the maximum volume. In another embodiment, the predetermined volume is at least about 20% of the maximum volume. In another embodiment, the predetermined volume is at least about 30% of the maximum volume.

According to a third aspect of the invention there is provided a distillation unit including:

a container for receiving a first liquid wherein the liquid is evaporated to form a liquid vapour;

a heat exchanger having a downwardly facing condensation surface both for condensing the liquid vapour that contacts that surface and for directing the condensate to a collection zone; and

a collector being disposed within the container for receiving the condensate and which, in use, retains at least about 0.5 litres of condensate.

In an embodiment, the collector retains at least about 1 litre of condensate. In an embodiment, the collector retains at least about 2 litres of condensate. In other embodiments, the collector retains greater the about 2 litres of condensate.

According to a fourth aspect of the invention there is provided a distillation unit including:

a container for receiving up to a maximum volume of a first liquid, wherein the first liquid is evaporated to form a liquid vapour;

a heat exchanger having a downwardly facing condensation surface both for condensing the liquid vapour that contacts that surface and for directing the condensate to a collection zone; and

a collector being disposed with the container for receiving the condensate and which, in use, retains at least a predetermined volume of the condensate, wherein the predetermined volume is at least about 2% of the maximum volume.

In an embodiment, the predetermined volume is at least about 5% of the maximum volume. In another embodiment, the predetermined volume is at least about 7% of the maximum volume, while in another embodiment, the predetermined volume is at least about 10% of the maximum volume.

According to a fifth aspect of the invention there is provided a distillation unit including:

a container for receiving a first liquid, wherein the first liquid is evaporated to form a liquid vapour;

a first heat exchanger having a condensation surface both for condensing the liquid vapour that contacts that surface and for directing the condensate to a collection zone;

a second heat exchange spaced apart from the first heat exchanger; and

a fluid pumping system for circulating a heat exchange medium between the first and second heat exchangers to transfer heat from the condensation surface.

In an embodiment, the second heat exchanger includes a reservoir for the medium, and the pumping system, in use, operates continuously. Preferably, when the pumping system is not in use, the medium drains to a reservoir. More preferably, when the pumping system is not in use, substantially all the medium drains to the reservoir. In some embodiments, the pumping system operates periodically or intermittently.

In an embodiment, the medium is contained within a closed system and is circulated between the first and second heat exchangers.

According to a sixth aspect of the invention there is provided a distillation unit including:

a base unit having a base, at least one sidewall extending upwardly from the base and a top for collectively defining a storage space;

a container disposed on or above the top for receiving first liquid that is evaporated to form a liquid vapour;

a first heat exchanger having:
(a) a condensation surface both for condensing the liquid vapour that contacts that surface and for directing the condensate to a collection zone; and
(b) a cavity for containing a heat exchange medium that draws heat from the condensation surface;

a collector being disposed within the container for receiving the condensate;

an outlet that extends from the collector for allowing the condensate to progress from the container; and

a second heat exchanger disposed within the storage space for cooling the heat exchange medium.

According to a seventh aspect of the invention there is provided method of distillation including:

receiving a first liquid in a container, wherein the liquid is evaporated to for a liquid vapour, the container having an upwardly facing opening defined by a peripheral edge;

engaging the edge with a heat exchanger that extends across at least substantially all the opening, the exchanger having a downwardly facing condensation surface both for condensing the liquid vapour that contacts that surface and for directing the condensate inwardly from the edge to a collection zone; and

disposing a collector within the container for receiving the condensate.

According to a eighth aspect of the invention there is provided a method of distillation using a container having an upwardly facing opening defined by a peripheral edge and a collector this is disposed within the container, wherein the container receives a first liquid that is evaporated to form a liquid vapour, the method including:

engaging the edge with a downwardly facing condensation surface that extends across at least substantially all the opening to both condense the liquid vapour that contacts the condensation surface and to direct the condensate inwardly from the edge toward the collector; and

engaging a heat exchanging surface with a heat exchange medium, the heat exchanging surface being in thermal contact with the condensation surface.

According to a ninth aspect of the invention there is provided a method of distillation including:

receiving a first liquid in a container, wherein the liquid is evaporated to form a liquid vapour;

providing a heat exchanger having a downwardly facing condensation surface both for condensing the liquid vapour that contacts that surface and for directing the condensate to a collection zone; and

disposing a collector within the container for receiving the condensate and which, in use, retains at least about 1.5 litres of the condensate.

According to a tenth aspect of the invention there is provided a method of distillation including:

receiving up to a maximum volume of a first liquid in a container, wherein the first liquid is evaporated to for a liquid vapour;

providing a heat exchanger having a downwardly facing condensation surface both for condensing the liquid vapour that contacts that surface and for directing the condensate to a collection zone; and

disposing a collector within the container for receiving the condensate and which, in use, retains at least a predetermined volume of the condensate, wherein the predetermined volume is at least about 2% of the maximum volume.

According to an eleventh aspect of the invention there is provided a method of distillation including:

receiving a first liquid in a container, wherein the first liquid is evaporated to form a liquid vapour;

providing a fast heat exchanger having a condensation surface both for condensing the liquid vapour that contacts that surface and for directing the condensate to a collection zone;

spacing a second heat exchange apart from the first heat exchanger; and

using a fluid pumping system for circulating a heat exchange medium between the first and second heat exchangers to transfer heat from the condensation surface.

According to a twelfth aspect of the invention there is provided a method of distillation including:

providing a base unit having a base, at least one sidewall extending upwardly from the base and a top for collectively defining a storage space;

disposing a container on or above the top for receiving a first liquid that is evaporated to form a liquid vapour,

providing a first heat exchanger having:
(a) a condensation surface both for condensing the liquid vapour that contacts that surface and for directing the condensate to a collection zone; and
(b) a cavity for containing a heat exchange medium that draws heat from the condensation surface;

disposing a collector within the container for receive the condensate;

extending an outlet from the collector for allowing the condensate to progress from the container; and

disposing a second heat exchanger within the storage space for cooling the heat exchange medium.

Unless the context clearly requires otherwise, throughout the description and the claims, the words ‘comprise’, ‘comprising’, ‘include’, ‘including’, and the like are to be construed in an inclusive sense as opposed to an exclusive or exhaustive sense; that is to say, in the sense of “including, but not limited to”.

### BRIEF DESCRIPTION OF THE DRAWINGS

The invention described herein is illustrated by way of example and not by way of limitation in the figures of the accompanying drawings in which like references indicate similar elements. It should be noted that references to “an” or “one” embodiment in this disclosure are not necessarily to the some embodiment, and such references mean at least one. Additionally, the drawings, while being indicative of relative proportions, are not exactly to scale.

The accompanying drawings include the following:

FIG. 1 is a side view of a distillation unit according to an embodiment of the invention;

FIG. 2 is a cross-sectional view taken along line 2-2 of FIG. 1;

FIG. 3 is a top view of the heat exchanger dish used in the FIG. 1 embodiment;

FIG. 4 is a side view of the heat exchanger dish of FIG. 1;

FIG. 5 is a bottom view of the heat exchanger dish of FIG. 1;

FIG. 6 is a top view of the pot used in the FIG. 1 embodiment;

FIG. 7 is a side view of the pot of FIG. 6;

FIG. 8 is a perspective view of the anti-reboil stand used in the FIG. 1 embodiment;

FIG. 9 is a cross-sectional view of a distillation unit according to another embodiment of the invention;

FIG. 10 is a side view of a heat exchanger for another embodiment of the invention;

FIG. 11 is a top view of a lid for the collector used with the heat exchanger of FIG. 10;

FIG. 12 is a cross-sectional view taken along section line 12-12 of FIG. 11; and

FIG. 13 is a cross-sectional view of the components of FIGS. 10 and 12, in situ;

FIG. 14 is a cross-sectional view of an alternative lid to the lid of FIG. 12;

FIG. 15 is a cross-sectional view of the of FIG. 12 with an alternative collector;

FIG. 16 is a cross-sectional view of the lid of FIG. 12 with an alternative collector;

FIG. 17 is a top view of one dish of a multi-dish heat exchanger of another embodiment of the invention;

FIG. 18 is a side view of the dish of FIG. 17;

FIG. 19 is a side view of two like dishes of FIG. 17 that are opposed and fixedly connected together to define a heat exchanger of an embodiment of the invention;

FIG. 20 is a sectional view taken through the centre of the heat exchanger of FIG. 19;

FIG. 21 is a partial sectional view of a distillation unit of a further embodiment that includes the heat exchanger of FIG. 19;

FIG. 22 is a sectional view, similar to FIG. 20, of an alternative embodiment of the heat exchanger;

FIG. 23 is a partial sectional view, similar to FIG. 21, of a distillation unit including the heat exchanger of FIG. 22;

FIG. 24 is a partial sectional view of the unit of FIG. 23 illustrating the collector and the external container for the condensate, wherein only the heated container—that is, the urn—is shown in section;

FIG. 25 is a cross-sectional view of an adaptor for the unit of FIG. 23;

FIG. 26 is a cross-sectional view of a further heat exchanger.

FIG. 27 is a side view of a further distillation unit according to the invention; and

FIG. 28 is a partial sectional view of a further distillation unit according to the invention.

### DETAILED DESCRIPTION OF THE EMBODIMENTS

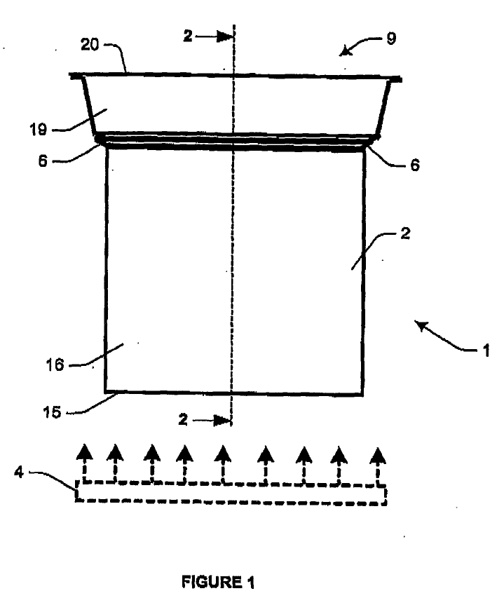

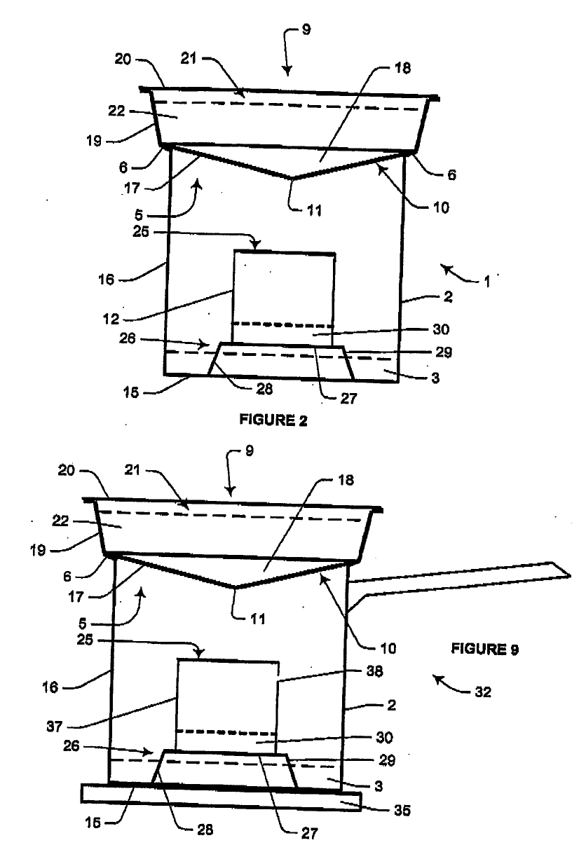

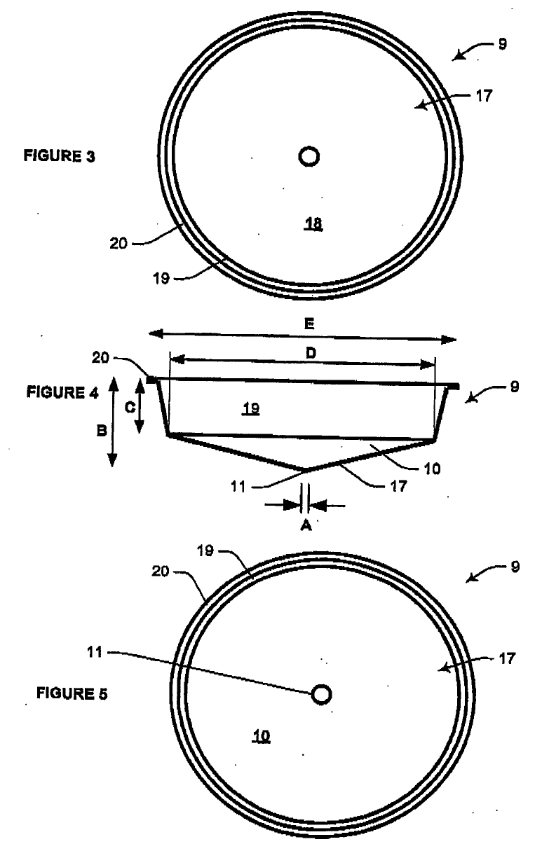

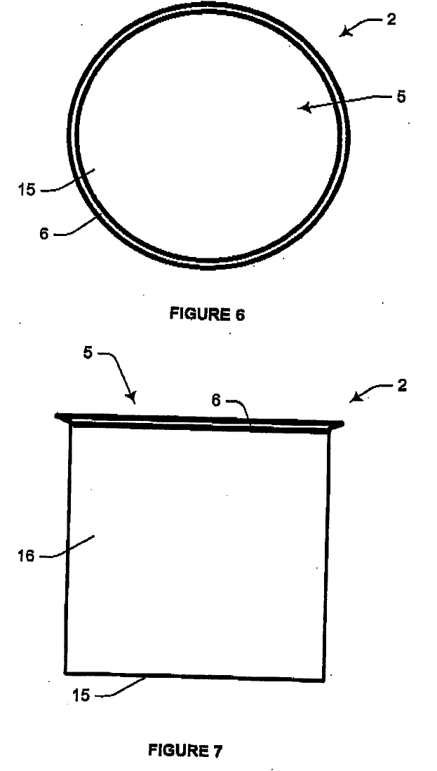

Referring to the drawings, an in particular to FIGS. 1 to 5, there is illustrated an embodiment of the invention in the form of a distillation unit 1 that is portable. The distillation unit includes a container in the form of a generally cylindrical steel pot 2—such as that commonly used by campers—for receiving, as best seen in FIG. 2, a first liquid in the form of river water 3. The river water is evaporated following application of heat from a heat source 4 to form a liquid vapour (not shown). Pot 2 has an upwardly facing generally circular opening 5 defined by a peripheral edge in the form of a continuous annular lip 6. A heat exchanger in the form of a generally circular stainless steel dish 9 engages substantially all of lip 6 and extends across substantially all of opening 5. Dish 9 has a downwardly facing substantially frusto-conical condensation surface 10 both for condensing the liquid vapour that contacts surface 10 and for directing the condensate inwardly from lip 6 to a central collection zone 11 that is a substantially planar and horizontal surface. A collector in the form of a metal drinking cup 12 is disposed within pot 2 for receiving the condensate.

Pot 2 includes a circular base 15, and an integrally formed cylindrical sidewall 16 that extends upwardly from the base and which terminates in lip 6. The pot has a volume of about 4 litres and, in use, has about 2 litres of water 3 placed within it and which is in contact with base 15. In other embodiments, pot 2 is other than cylindrical and made of other than metal. Metal is used in this embodiment due primarily to cost, and the fact that heat source 4 is an open fire. In other embodiments, source 4 is a gas or other fuel burner, while in other embodiments source 4 is powered otherwise, such as by electrical current. For example, in an embodiment, pot 2 is placed on or above a heat source such as a domestic stove element. Water 3 is, in this embodiment, raw water such as river water, seawater, dam water, or the like. However, in other embodiments, alternative sources of water are used.

In this embodiment, dish 9 is made from 316 grade stainless. Moreover, at least surface 10 of dish 9 is highly finished. In other embodiments, dish 9 is made from marine grade aluminium. In still further embodiments, dish 9 is made of a combination of materials, such as an outer layer of aluminium, and an inner layer of stainless steel.

In this embodiment, the finish is referred to as a finish, which includes a fine surface grinding followed by a polish. This has the effect of removing surface irregularities such as circumferential corrugations that often arise from the formation of a conical or frusto-conical surface such as surface 10. The removal of these corrugations and other irregularities ensures that surface 10 is smooth and conducive to the downward and inward progression of the condensate along the surface and toward zone 11. In other embodiments other finishes are used. The conventional wisdom is that a condensation surface should be irregular, corrugated, or otherwise formed to increase the available surface area for condensation and cooling.

In other embodiments, opening 5 is other than substantially circular, and other than substantially horizontal.

In other embodiments, the water is tap water, filtered water, seawater, rainwater, or other water that a person wishes to distil.

Dish 9 includes an inner frusto-conical stainless steel sheet portion 17, one side of which defines surface 10, and the opposite side of which defines a heat exchanging surface 18. Dish 9 also includes an outer annular portion 19 that is integrally formed with and extends radially outwardly and away from the outer radial periphery of portion 17 and which terminates in an upper annular lip 20 to define a receptacle 21. Ir use, the receptacle is: left empty; provided with a heat exchange fluid—such as non-distilled water 22 in this embodiment—that is engaged with surface 18 to increase the rate of the distillation of the water within pot 2 by removing heat from that surface and, hence, from surface 10; or filled with one or more fluids, solids or mixture thereof—such as food—to make additional use of the heat emanating from surface 18.

Surface 10 is inclined with respect to the horizontal by about 23°. However, in alternative embodiments, surface 10 is inclined at different angles. It has been found by the inventors that angles of inclination of between about 10° and 50° are typically acceptable, although more favourable results are often achieved when surface 10 is inclined with respect to the horizontal by between about 15° and 35°. In some embodiments, such as the above embodiment where use is made of highly finished 316 grade stainless steel, it has been found that surface 10 is best inclined with respect to the horizontal by between 20° and 30°.

The frusto-conical nature of portion 17 allows dish 9 to be used with not only pot 2, but also with other pots or containers having circular openings of a different diameter to that of pot 2.

As illustrated in FIG. 4, dish 9 has key dimension labelled as “A”, “B”, “C”, “D” and “E”. In this embodiment, those dimensions are respectively 30 mm, 90 mm, 32 mm. 297 mm, and 320 mm. In other embodiments alternative dimensions are used. For example, in some embodiments, dimension A is 0 mm, and surface 10 is conical. In other embodiments, where dish 9 is intended for use with a drum or other container having a relatively large opening, dimension D is about 1 m. The inventors have constructed a dish 9 whore dimension D is about 2 m.

Surface 10 and lip 6 of pot 2 are substantially complementarily shaped to encourage the formation of a seal between them. Surface 10 is gravitationally biased into engagement with lip 6 due to the weight of dish 9 and any heat exchanging liquid or other material contained within the dish. The effect of this bias, together with the combination of wet steam within pot 2, is such as to create a partial or total seal between surface 10 and lip 6. Although the existence of a partial seal will result in slightly less yield that is the case for a total seal, this is often not of great consequence and allows the use of less exacting, and typically less expensive, manufacturing tooling, and quality control steps.

The application of heat from source 4 will result in the creation of the water vapour from water 3, with a resultant build up of pressure within pot 2. Should that pressure be sufficient to overcome the gravitational bias, the seal will be broken and water vapour allowed to escape. In his embodiment, this mechanism acts as a safety release valve to protect against the build up of pressure within pot 2.

In other embodiments, the container and the heat exchanger are mechanically connected and a valve is included to relieve any undesirable pressure build up in the is container. The mechanical connection arises in some embodiments by fastening devices such as screws, straps, bolts or the like, or through other connections such as integrally for the components, welding, soldering, adhering or otherwise.

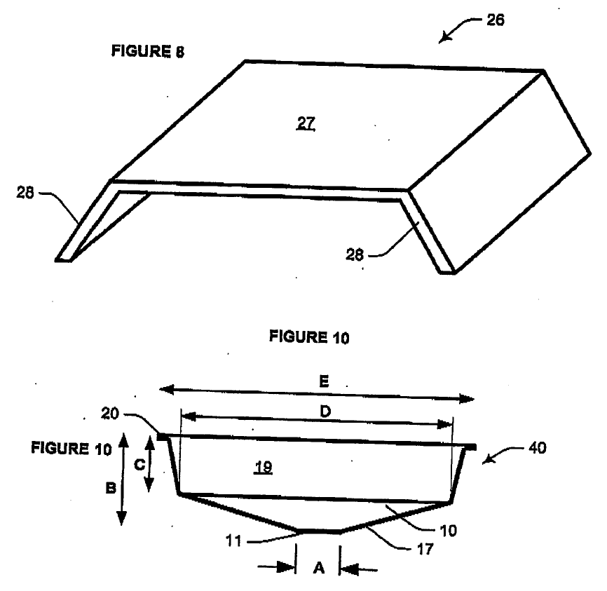

Cup 12 includes an upwardly facing substantially circular opening 25 and is disposed within pot 2 and maintained above base 15 by an anti-reboil stand 26. Stand 26, as best shown in FIG. 8, is integrally formed from metal and includes a substantially planar horizontal platform 27 for supporting cup 12, and two legs 28 and 29 that extend downwardly and away from respective opposite edges of the platform for engaging with base 15. In this embodiment, stand 26 is formed from 316 grade stainless steel. In other embodiments, use is made of other metals such as aluminium or copper, while in further embodiments, use is made of plastics.

In use, stand 26 is initially placed within pot 2 and disposed centrally on base 15. Water 3, which is to be distilled, is then placed within pot 2 up to about the level of platform 27. In this embodiment, that equates to about 1 litre of water. It will be appreciated that where use is made of a different size pot or a stand of differing so height that a different volume of water 3 will be contained within the pot.

An empty cup 12 is then placed centrally upon platform 27 with opening 26 upwardly disposed. As the name of stand 26 implies, it is used to reduce the risk of distilled water ultimately collected within cup 12 from re-boiling and thereby re-entering pot 2 as water vapour.

Dish 9 is positioned above pot 2, and moved downwardly such that collection zone 11 is progressed through enters opening 5 until surface 10 engages with lip 6. Some minor relative positional adjustments of dish 9 and lip 6 may be required to obtain the best possible fit between these elements. That said; the frusto-conical nature of surface 10 facilitates such a fit.

Collection zone 11 is of a lesser diameter than opening 26 and is disposed above but wholly within the radial extent of that opening. As illustrated, zone 11 and opening 26, while being vertically spaced apart, are coaxially disposed. In other embodiments, zone 11 and opening 26 are other than coaxial.

If required, additional non-distilled water 22 is included within cavity 21, and the assembled elements placed such that base 15 is disposed directly over heat source 4, as shown in FIG. 1. The application of heat causes the creation of water vapour or wet steam within pot 2 which rises to contact surface 10. Where the complementary fit between surface 10 and lip 6 is sufficient, the water vapour will affect a seal between those two elements.

Once the water vapour contacts surface 10 and is cooled, it returns to a liquid state and, under the influence of gravity, progresses down surface 10 to zone 11. When unit 1 operates with water 22, surface 10 is maintained at a lower temperature and is therefore able to condense the water vapour at a greater rate.

The condensed water (not shown) that reaches zone 11 falls from dish 9 and trough the underlying opening 26 in cup 12 where it collects as distilled water 30. Once a desired quantity of water 30 is collected within cup 5, unit 1 is removed from heat source 4, dish 9 removed from opening 5, and cup removed from pot 2.

The above process is repeated, as required to obtain a greater quantity of distilled water.

It has been found that for the above embodiment it is possible to distil about 1 litre of water in about one hour, and that this results in the temperature of water 22 being raised to about 80° C. This occurs when source 4 is able to maintain water 3 at or about 100° C. and where dish 9 contains about 3 litres of water 22. In cold conditions, or where greater quantities of water 22 are used, better results are obtainable.

A further embodiment of the invention, in the form of a distillation unit 32 is illustrated in FIG. 9, where corresponding features are denoted by corresponding reference numerals. In this embodiment all the elements are identical, with the exception of:
The container which, rater than being pot 2, is a domestic saucepan 33.
The heat source 4 which, rather than being an open fire, is a stove top electric element 35,
The collector which, rather than being a cup 12, is a stainless steel dish 37 having an overflow aperture 38 for reducing the risk of unit 32 boiling dry. That is, should dish 37 fill to overflowing, the overflow will be directly returned to saucepan 33 and thereby provide the user with additional time to return to unit 32.

The operation of unit 32 is similar to that described with reference to the first embodiment. Accordingly, it has been found that this second embodiment also produces distilled water (or distillate) at about the same rate as the earlier described embodiment.

A further embodiment of the invention includes a dish 40, as best illustrated in FIG. 10, and where corresponding features are denoted by corresponding reference numerals. This dish is intended for use with a container such as that illustrated in the earlier figures, or functional equivalents thereof. In this embodiment, dish 40 includes dimensions “A”, “B”, “C”, “D” and “E” of respectively 55 mm, 90 mm, 32 mm, 297 mm, and 320 mm. The angle surface 10 is inclined with respect to the horizontal is about 25°. Zone 11 includes a substantially planar horizontal circular surface that is downwardly facing and which is integrally formed with and inclined with respect to the surrounding wall 17. As the condensate moves to the intersection of frusto-conical wall 17 and circular zone 11 it falls downwardly from dish 40.

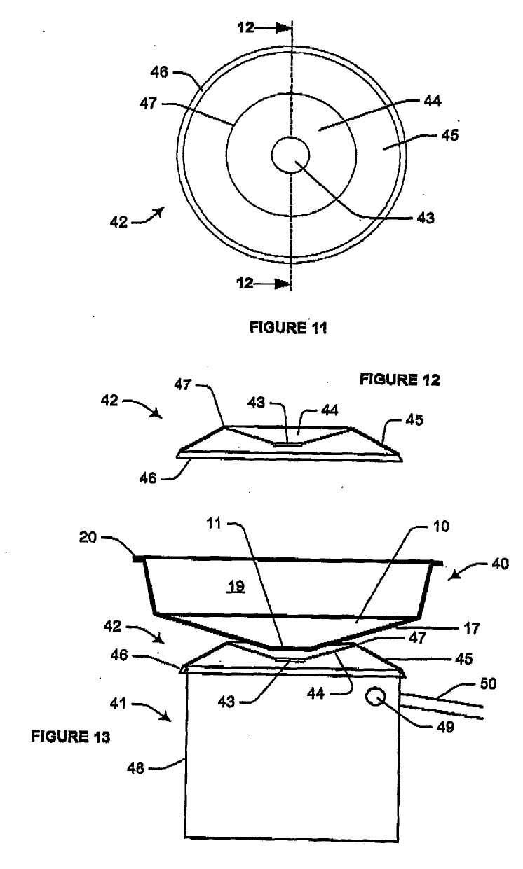

In some embodiments, the collector includes a collector body, and a closure for that body, such as that illustrated in FIGS. 11 and 12. More particularly, there is shown in those drawings, a closure for a collector 41 in the form of a generally circular formed metal lid 42 having a central substantially circular collector opening 43. Lid 42 is, in use, disposed over and concentric with upwardly facing opening 5 of the collector for allowing the condensate falling from zone 11 to enter the collector. In this embodiment, lid 42 engages with the remainder of the collector in a releasable interference fit. However, in other embodiments, the lid is fixedly mounted to the collector body. In still further embodiments, the lid is integrally formed with the collector body.

Lid 42 includes a first annular zone 44 that surrounds and is concentric with opening 43, a second zone 45 that surrounds and is concentric with zone 44, and a downwardly depending continuous circumferential lip 46. The condensate contacting zone 44 is progressed toward opening 43, while the condensate contacting zone 45 is directed away from opening 43 and back into the container. More particularly, zone 44 defines a flannel between opening 43 and the circular intersection 47 between zone 44 and zone 45. Accordingly, condensate contacting this surface will progress, under the influence of gravity, toward opening 43. Zone 45, on the other hand, defines an upwardly facing surface that declines radially from intersection 47. Accordingly, condensate contacting this latter surface will progress, under the influence of gravity, away from opening 43, across lip 46 and back into the container.

FIG. 13 illustrates, in situ, collector 41, lid 42, and dish 40, where the container has been omitted for the purposes of clarity. As with the earlier described embodiments, collector 41 is disposed within the container, while surface 10 of dish 40 seals an opening (not shown) of that same container. Collector 41 includes a collector body 48 having an upper periphery into which lid 42 is engaged in an interference fit. Body 48 includes an outlet aperture 49 adjacent to the upper periphery for allowing the condensate, once sufficient has collected with body 48, to progress out of collector 41. An outlet pipe 50 extends from the aperture 49 and through the wall of the container (not shown) for delivering the condensate to an external store (not shown).

In use, zone 44 underlies and extends horizontally beyond zone 11 to ensure all condensate falling from the latter zone is progressed trough opening 43 and into the collector. It will also be noted that zone 11 is disposed below the opening in the collector and below intersection 47.

The inclination of zone 44 with respect to the horizontal is similar to the inclination of surface 10 with respect to the horizontal. That is, zone 44 is parallel with and opposed to the adjacent surface 10. Moreover, due to the relatively small vertical distance between these elements—about 10 mm in this embodiment—most of the condensate forms closer to the radial periphery of surface 10. In other words, most of the condensate forms on that portion of surface 10 that is directly above or radially outwardly from zone 45. It has been found that this is useful in further improving the quality of the condensate delivered to collector 41. Particularly, as the water vapour produced within the container is “wet steam”, there is a risk that some impurities will be entrained within the steam and released to fall under the influence of gravity once the condensate is formed. As most of the condensate is formed at the radial outer portions of surface 10, the greater majority of the entrained impurities will, once the condensation occurs, fall downwardly onto zone 45 and/or into the container. The condensate, now separated from those impurities, is retained in engagement with surface 10 by way of surface tension, and progressed downwardly toward zone 11 under the influence of gravity.

In other embodiments, the vertical distance between zone 44 and surface 10 is other than 10 mm. Additionally, in some embodiments, zone 44 and surface 10 are not parallel. For example, in one embodiment (not shown), the vertical distance between zone 44 and surface 10 increases with the radial distance from zone 1.

In this embodiment the container has a volume of about 20 litres, and is provided with a maximum volume of about 7 litres of water to be distilled. Collector 41 has a volume of slightly greater than about 2 litres, and retains about 2 litres of condensate prior to any being passed through aperture 49 and pipe 50. In other embodiments, collector 41 rets at least about 0.5 litres of condensate, although in further embodiments, collector 41 retains at least about 1 litre of condensate. In another embodiment, the collector retains greater than about 2 litres of condensate.

It has been round by the inventors that good rates of high quality distillate are produced in circumstances where the collector, which is disposed within the container, retains at least a predetermined volume of the condensate relative to the maximum volume of raw water contained within the container. In some embodiments, the predetermined volume is at least about 2% of the maximum volume. In another embodiment, the predetermined volume is at least about 5% of the maximum volume. In a further embodiment, the predetermined volume is at least about 7% of the maximum volume, while in another embodiment, the predetermined volume is at least about 10% of the maximum volume. As presently understood, the retention of the condensate within the collector provides a heat sink that assists in maintaining surface 10 at conditions more conducive to the formation of condensate.

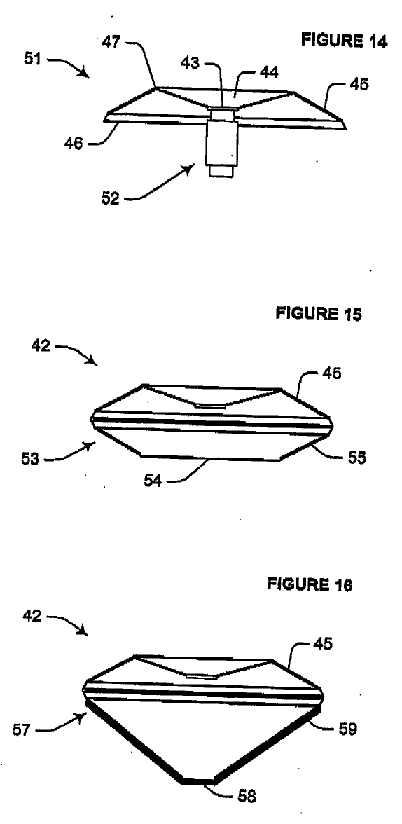

FIG. 14 illustrates a lid 51 similar to lid 42 of FIG. 12, where corresponding features are denoted by corresponding reference numerals. Lid 51 includes a filter 52 that is disposed directly downstream of opening 43. That is, the condensate, upon progressing through opening 43, then passes through filter 52 and then into the collector (not shown). In this embodiment, filter 52 is an activated carbon filter for removing any residual odour or minor impurities. As the level of such odours and impurities is very low—in the order of 2% of the levels in the raw water—filter 52 is able to effectively last long periods between services. In this embodiment, filter 52 containing 15 grams of activated carbon. Moreover, filter 52 is, in this embodiment, detachable from opening 43, and able to be emptied of the spent carbon particles, and refilled with fresh carbon particles. That being so, even when a service is required, it is able to be extremely cost effectively canned out. It will be appreciated that filter 52 is used in those applications where there is a desire to further enhance the purity of the condensate. It has been found that this provides some benefit, albeit sometimes only subjectively.

In other embodiments filter 52, or an equivalent post-distillation filter, is disposed external to the collector. In further embodiments, filter 52, or an equivalent post-distillation filter, is disposed external to the container in which the raw water is heated.

After repeated use of the distillation units of the above embodiments, there will be a build-up of residue, particularly within the container and, if a lid is used, on that lid. The rate of build-up of this residue is dependent upon a variety of factors such as, for example, tee temperature to which the raw water is heated, the regularity of use of the unit, and the degree of sediment or other impurities contained within the water to be distilled. Accordingly, the units will benefit from a periodic cleaning to ensure correct operation and quality of the condensate produced. This cleaning is facilitated by the relatively straightforward nature of the units and their inter-related components. That is, the units are all easily disassembled, cleaned and re-assembled for use in a matter of minutes. Accordingly, the cleaning operation is inexpensive to perform, is performed without the need for skilled or specialised and expensive labour and requires piety little downtime. The latter factor is particularly advantageous for those units that operate substantially continuously.

To further the interval between cleaning and/or servicing of the distillation unit, some embodiments employ a pre-filtering of the raw water to be distilled. In an embodiment, the pre-filtering is by way of an activated carbon filter, while in other embodiments another filter type or types are used.

FIG. 15 illustrates a further embodiment of the invention that makes use of a collector in the form of a 316 grade stainless steel frusto-conical dish 53. The dish includes a circular base 54 flat is substantially radially equivalent to and coaxial with circumferential interface 47. A conical sidewall 55 extends upwardly and away from base 54 at an angle complementary to that of zone 45. In this embodiment, dish 53 and lid 42 are made by the same process, with lid 42 undergoing additional forming steps to create zone 44 and opening 43. One of the two components—that is, one of lid 42 and dish 53—is inverted with respect to the other, and opposed like openings are brought together. In his embodiment, the openings are fixedly secured together by welding. In other embodiments, the securing is by way of other means such as soldering, rivets, screws, bolts, clasps or the like. In alternative embodiments, the opposed components are held together in an interference fit. Is still further embodiments, the components are releaseably secured to allow them to be selectively nested one within the other. In those embodiments, lid 42 and 53 are also formed to complementarily nest within the heat exchanger and the container for facilitating packaging of the unit. Collector 53 includes an aperture 49 and pipe 50—neither of which are shown—to allow the condensate to drain from the collector while still retaining a predetermined volume of condensate within the collector.

An alternative embodiment of the invention is illustrated in FIG. 16, where corresponding feature are denoted by corresponding reference numerals. Particularly, a collector is in the form of a 316 grade stainless steel frusto-conical dish 57. The dish includes a circular base 58 that is substantially radially equivalent to and coaxial with opening 43. A conical sidewall 59 extends upwardly and away from base 58 at an angle approximately complementary to that of zone 45. In this embodiment, dish 57 and lid 42 are made by the same process, with lid 42 undergoing additional forming steps to create zone 44 and opening 43. Collector 57 includes an aperture 49 adjacent to its top edge and a pipe 50—neither of which is shown in FIG. 16—to ensure that, during use, a predetermined volume of condensate is retained with in the collector.

Collector 57 retains a greater volume of the condensate than does collector 43. In particular, collector 43 retains about 1.5 litres of condensate, which collector 57 retains about 3 litres. That is, collector 57 is designed for use with larger volume and deeper containers. As mentioned above, the retained volume of condensate is, in these embodiments, at least about 2% of the maximum volume of raw water contained within the container, and where possible, greater than at least about 5% of the maximum volume. In a further embodiment, the predetermined volume is at least about 7% of the maximum volume, while in another embodiment, the predetermined volume is at least about 10% of the maximum volume.

In other embodiments, different volumes of condensate are retained, during use, within the collector. For domestic applications—such as used in a household or office environment—it has been found that at least about 1 litre of water is retained within the collector. If the distillation unit is operating in a batch mode as opposed to a continuous mode, the condensate that is retained within the collector is removed—typically for consumption—at the end of each batch.

Sidewalls 55 and 59 are inclined with respect to the horizontal by about 23° and 40° respectively. (It will be appreciated that the Figure are not necessarily to scale). However, in alternative embodiments, these sidewalls are inclined at different angles. As wilt surface 10 of the FIG. 1 embodiment, it has been found by the inventors that angles of inclination for sidewalls 55 and 59 of between about 10° and 50° are typically acceptable, although more favourable results are often achieved when sidewalls 55 and 59 are inclined with respect to the horizontal by between about 15° and 35°. In some embodiments where use is made of highly finished 316 grade stainless steel, it has been found that surface 10 is best inclined with respect to the horizontal by between 20° and 30°.

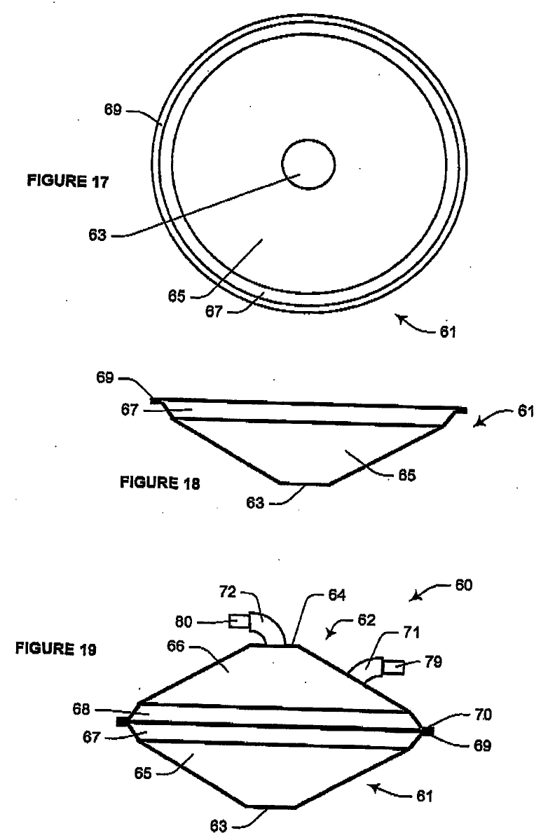

In those embodiments where even greater rates of distillation are required, use is made of an alternative heat exchanger such as the heat exchanger 60 that illustrated in FIG. 19. Exchanger 60 includes two opposed frusto-conical dishes 61 and 62. For the sake of illustration, dish 61 is illustrated in FIGS. 17 and 18 prior to its connection to dish 62. These dishes are similar in shape to dish 9. While dish 61 is produced from 316 grade stainless steel, dish 62 is made from a softer metal such as, for example, brass or copper. This is predominantly driven by cost, in that the softer metal is a less expensive raw material but due to the similar shape, is able to be formed with the same tooling as that used for dish 61. Additionally, brass and copper are stable when abutted to stainless steel. There are also aesthetic considerations, as brass particularly is able to be similarly finished to the stainless steel. The aesthetics of a continuous and smooth rolled edge are typically preferred over that of a less uniform connection such as a weld.

Dishes 61 and 62 include respective: central, substantially planar circular zones 63 and 64; frusto-conical surfaces 65 and 66 that extends radially outwardly and away from zones 63 and 64; annular portions 67 and 68 that extend radially outwardly and away from portions 65 and 66; and circumferential lips 69 and 70 that extend radially outwardly from portions 67 and 68 to define the radial periphery of the respective dishes.

Dishes 61 and 62 are separately formed, and dish 61 finished similarly to dish 9. It will be appreciated from the following description that surface 66 is not intended for condensing the water and, as such, it is not required to be finished in the same manner as surface 65. However, due to the aesthetically attractive nature of that finish, and the complication of having to differently manufacture two otherwise like elements, it is usual for both dishes 61 and 62 to include a like fish, or at least to be finished such that they have a similar visual appearance.

Prior to use, dishes 61 and 62 are opposed with adjacent lips 69 and 70 being abutted along the entirety of their peripheries. Thereafter, the lips are sealingly connected to each other. In this embodiment, that connection is by way of a weld that extends about the outer radial periphery of the lips. In other embodiment, use is made of other fixed and sealed connections, such as one or a combination of braising, soldering, adhering, or otherwise. In some embodiments use is made of one or more sealants between the lips such a rubber gasket or paste, tape, or the like. The sealant or sealants are, in some embodiments, used in combination wink one or more of rivets, bolts, screws clamps, tensioned bands and the like. That is, some embodiments makes use of a fixed connection between dishes 61 and 62, while other embodiments make use of a releasable connection. Other embodiments affect the connection between the dishes by rolling one of lips 69 or 70 over the other. Where dish 62 is of a softer metal, it is usual to have lip 70 formed so as to extend radially beyond lip 69 and then to roll lip 70 over lip 69. That is, the softer metal is rolled over the harder metal to facilitate the rolling operation. The rolling, in some embodiments, occurs in combination with other sealing or connections.

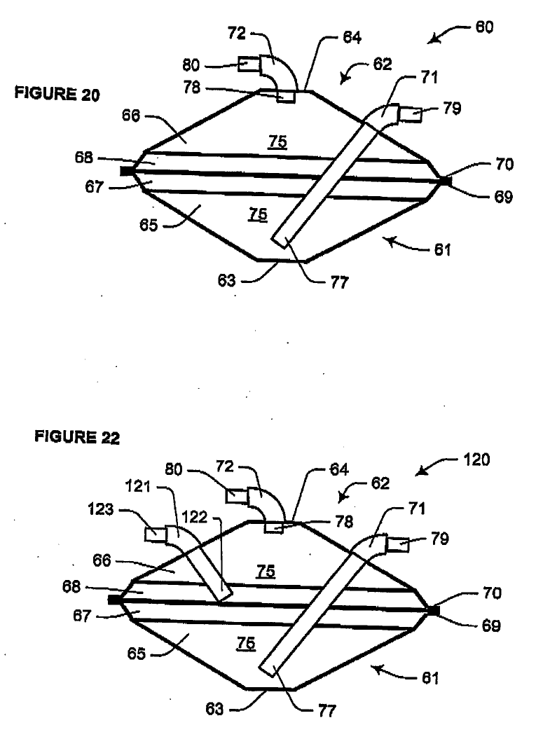

Prior to the connection being affected between dishes 61 and 62, dish 62 is modified to include a coolant inlet in the form of a curved stainless steel pipe 71 and a coolant outlet in the form of a curved stainless steel pipe 72. These pipes are best shown in FIG. 20, and extend through surface 66 and zone 64 respectively and into a single cavity 75 defined between the opposed dishes 61 and 62. Pipes 71 and 72 extend between respective inner ends 77 and 78 that are disposed within cavity 75 to respective outer ends 79 and 80 that are disposed external to cavity 75. Ends 79 and 80 are of reduced diameter for facilitating the connection of conduits (not shown) that direct flows of coolant to and from the cavity.

As will be appreciated from the teaching herein, zone 63 is inclined with respect to surface 65 such that the condensate moving down that surface will fall from the dish and into the underlying collector. Moreover, zone 64 is inclined with respect to surface 66 to provide a convenience site for an outlet from cavity 75. The planar nature of these zones also provides manufacturing advantage, in that they allow the use of a spinning operation, which is generally a more cost effective method for products having the tolerances of those used in the embodiments. That is, zones 63 and 64 provide respective sites for mounting the pre-formed material to the tooling, and define a central point about which the material is rotated during the spinning operation.

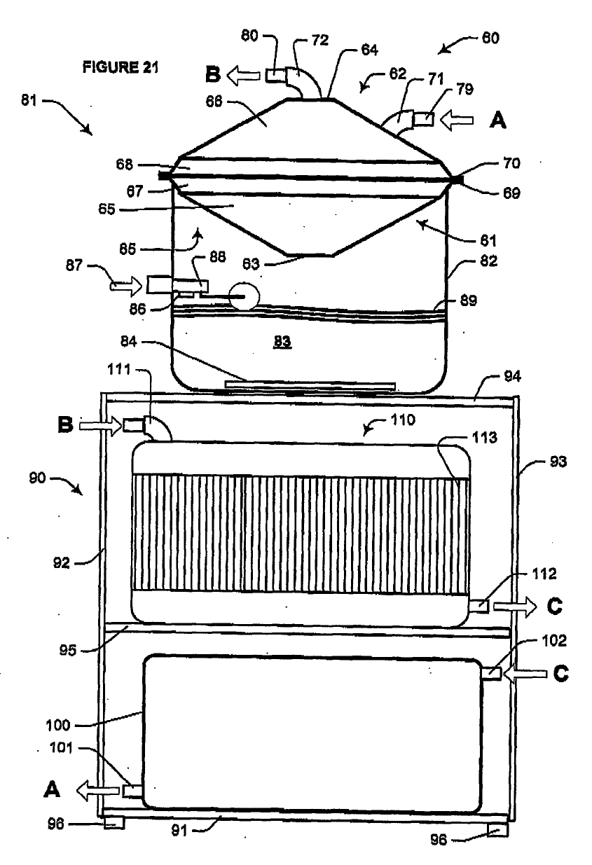

Reference is now made to FIG. 21 where exchanger 60 is illustrated in situ with a distillation unit 81. The distillation unit includes The distillation unit includes a container in the form of a generally cylindrical stainless steel water urn 82—such as that commonly used in domestic or office applications for providing heated water for beverages—for receiving a first liquid in the form of mains water 83 that is provided by a pubic water utility. The water is evaporated following application of heat from a thermostatically controlled 2.4 kW electric element 84 that is disposed at the base of urn 82, to form a liquid vapour (not shown). Urn 2 has an upwardly facing generally circular opening 85 defined by a peripheral edge. Dish 61 of heat exchanger 60 engages substantially all of the peripheral edge and extends across substantially all of, and downwardly through, opening 85. Surface 65 of dish 61 provides a site for condensing the liquid vapour that contacts that surface, and for directing the condensate radially inwardly and downwardly to collection zone 63. For the sake of clarity in this Figure, the collector has been omitted. Notwithstanding, it will be appreciated that, in use, such a collector is included within urn 82, together with an aperture 49 and pipe 50 for allowing the condensate to be removed from the urn. It should also be appreciated that the height of urn 82 is not shown to scale. It is typical for that height to be greater than the proportions of FIG. 21 illustratively provide.

Collector 42 is suitable for use with this embodiment and is mounted to a wire frame (not shown) that extends radially inwardly from circumferentially spaced connections with the wall of urn 82. The frame maintains the collector in a fixed configuration relative to zone 63 such that condensate is collected as it falls downwardly from that zone. Other similarly configured and sized collectors are also used in other embodiments. Moreover, in some embodiments, the frame is substituted by an anti re-boil stand that sits on the base of urn 82.

Urn 82 includes a water inlet 86 that is connected, in this embodiment, to a domestic water supply (not shown). The water from that supply progresses in the direction of arrow 87 toward inlet 86 under the influence of the mains water pressure. Urn 82 also includes an internal float valve 88 that is design for operation at the temperatures and pressures involve. Valve 88 allows the mains water to flow through inlet 86 and replenish water 83 until such time as the water level 89 reaches the point illustrated in the Figure. As water 83 is heated by element 84 it evaporates and water level 89 falls. Once this has occurred to a sufficient extent, the float of valve 88 drops, and water 83 is replenished with further water from the mains water supply.

In this embodiment, the volume of water within urn 82, when that water is at the level 89, defines the maximum volume for unit 81. That maximum volume is about 20 litres, although in other embodiments different maximum volumes are used. Collector 42, in this embodiment, retains in use about three litres of condensate, which is about 15% of the maximum volume. In other embodiments alternative collectors are used that retain other volumes of the condensate.

It will be appreciated that as exchanger 60 is, in this embodiment, only gravitationally biased into sealing engagement with urn 82, it is possible to simply lift the exchanger upwardly to overcome that bias, and to allow a visual inspection of the contents of urn 82. Due to the low temperature and pressure operation of unit 81, the removal or movement of exchanger 60 in this way is not a critical safety issue. Clearly, it is undesirable to have the exchanger out of the operable position for other than short periods or the efficiency of unit 81 will degrade. Typically, however, the user simply wishes to conduct a quick visual inspection of the level of deposits within urn 82 to assess the timing of next cleaning and/or servicing of the urn, the collector, the condensation surface or other components within the urn.

Valve 88 does not allow the water within urn 82 to fall far below level 89 before it allows additional water to enter the urn and return the water to level 89. This has the affect of minimising temperature fluctuations within the urn and thereby maintaining consistent operating conditions for the production of condensate. This affect is also further by the thermal inertia gained through retention of at least a predetermined amount of the condensate within the collector that is itself disposed within the heating chamber that is the urn.

The frequent operation of valve 88 also reduces the risk of the new water entering urn 82 creating turbulence or splashing within the urn. This is preferred to minimise the risk of any of that water inadvertently entering the collector without having first been converted to vapour and then condensed. In some embodiments, inlet 86 is elongate and terminates adjacent to the base of urn 82 to further reduce this risk.

Urn 82 includes an outlet (not shown) for allowing water contained within the urn to be removed. This outlet is used to drain any water from the urn prior to cleaning and/or other maintenance. In this embodiment, the outlet is a tap, while in other embodiments the outlet includes a valve, plug or other stopper.

The condensation of the water vapour on surface 65 results in the release of latent heat held in the water vapour. This heat is absorbed by dish 61. To increase the rate of condensation, this embodiment employs a heat exchange medium that is disposed within cavity 75 for removing heat from surface 65 and dish 61. The specific heat exchange medium used is mains water as this embodiment is designed for low purchase and maintenance costs. However, in other embodiments, use is made of other media or combinations of media, such as treated water and other liquids. Where cost is less of a design limitation, use is made of fluids other than liquids.

Unit 81 includes a stand 90 that, in this embodiment, is constructed from wooden panels including:
A substantially horizontal base panel 91.
Two parallel opposed and spaced apart substantially vertical side panels 92 and 93 that extend upwardly from opposite sides of panel 91,
A top panel 94 that extends between panels 92 and 93 and which is spaced apart from and substantially parallel with panel 91.
An intermediate panel 95 that extends between panels 92 and 93 and which is spaced apart from and substantially parallel with panels 91 and 94.
Four spaced apart wooden feet 96 (only two shown) for maintaining panel 91 spaced apart from the surface upon which the stand is supported.

In use, stand 90 includes a removable front panel of lighter weight material that extends vertically between panels 91 and 94, and horizontally between panels 92 and 93. In some embodiments, stand 90 includes a rear panel similar to the front panel.

In other embodiments, stand 90 includes one or more castors, sliders or other devices for facilitating physical movement of the stand. In other embodiments, stand 90 is part of or inter with a bench, cupboard or other piece of furniture, or mounted to a trolley, or mounted externally. It will be appreciated that due to the low temperature operation of urn 82 it is possible to have that urn contained within an enclosed space, thereby reducing the risk of inadvertent contact.

Unit 81 includes a substantially prismatic plastics tank 100 that is disposed on panel 91 of stand 90 for providing a reservoir of about 30 litres of the heat exchange medium. As mentioned above, the heat exchange medium used in this embodiment is water. More particularly, the water is distilled water that was earlier produced by unit 81. In other embodiments alternative sources of distilled water are used, while in alternative embodiments, other than distilled water is used.

Tank 100 has a capacity of about 50 litres, the reason for which will become clear in the following description. In other embodiments alternative capacities are used, as are tanks made of other materials, such as steel or other metals.

Tank 100 includes an internal submersible electric pump (not shown) that continuously runs to pump water from within tank 100 and through an outlet 101 at the rate of about 16 litres/minute. In other embodiments different rates are used. In father embodiments, the pump operates periodically, and not continuously, while in further embodiments again, the pump operates intermittently. For example, in an embodiment, the pump includes a controller that is responsive to the temperature of the water within cavity 75 for determining when to operate the pump, and at what rate. In other embodiments, the controller is responsive to other inputs, such as the temperature of the water within tank 100 and/or the temperature of water 83.

Tank 100 also includes an inlet 102 that is disposed toward the top of the tank. Moreover, outlet 101 is disposed toward the bottom of the tank, and at the opposite side to inlet 102. This is intended to provide the water entering tank 100 through inlet 102 the opportunity to mix with the other water or, if still at a relatively high temperature to that water, to remain toward the top of the tank and thereby gain more time to cool prior to being directed by the pump through outlet 101. In some embodiments, tank 100 includes internal baffles to increase the degree of segregation between the incoming and outgoing water.

The water that is pumped through outlet 101 is directed—as schematically indicated by the arrows marked as “A”—to pipe 71 and thereafter into cavity 75. It will be appreciated by the skilled addressee, that outlet 101 and pipe 71 are, in use, connected by a fluid conduit such as a flexible hose or metal piping (neither of which are shown). Such a conduit has ends that are configured for complementary and a sealing engagement with respective ones of outlet 101 and pipe 71.

End 77 of pipe 71 is disposed in the lower half of cavity 75 and, in particular, is disposed as far downwardly within the cavity as possible. In this embodiment, end 77 is adjacent to zone 63 such that the water entering cavity 75 is immediately in the vicinity of dish 61. It will be appreciated by the skilled addressee that, in use, the water entering cavity 75 from end 77 of pipe 71 has a low temperature relative to the water already within the cavity. Accordingly, for optimal effect, the lower temperature water is disposed as close as possible the surface 65.

Unit 81 includes an external heat exchanger in the form of a gravity fed generally rectangular aluminum water-to-air radiator 110. The radiator includes a single continuously downwardly progressing serpentine flow path (not explicitly illustrated in the drawing) that winds from an upper inlet 111 to a lower outlet 112. The flow path is in close thermal contact with a plurality of spaced apart cooling fins 113 for allowing effective heat exchange between the water moving along the path and the air surrounding the fins. In other embodiments use is made of alternative external heat exchangers having one or more flow paths. For example, in a simplified embodiment, the external heat exchanger is comprised of tank 100, in that radiator 110 is omitted altogether. It will be appreciated that the larger the capacity of tank 100, and the greater its surface area and thermal conductivity, the greater the heat exchanging effect it provides.

In further embodiments, use is made of a fan or other forced air device for causing air to flow through radiator 110. In some of these embodiments, unit 81 includes a controller that is responsive to the temperature of the water at outlet 112 for selectively actuating the forced air device. In other embodiments, the controller is responsive to one or more inputs, such as: the temperature of the water at outlet 112; the temperature of the water in tank 100; the ambient air temperature; the temperature differential between inlet 111 and outlet 112; and others. In some embodiments, a controller is not used and the forced air device operates continuously, periodically, or intermittently.

Returning now to heat exchanger 60, the inflow of the relatively low temperature water into cavity 75 not only results in the upward progression within the cavity of the relatively high temperature water, but also in the displacement of some or all of that relatively high temperature water through pipe 72. The water that emerges from that pipe is directed—as schematically indicated by the arrows marked as “B”—to inlet 111. From there, the water progresses along the serpentine path and progressively exchanges energy with the surrounding air such that is emerges from outlet 112 at a relatively low temperature. The water emerging from outlet 112 is directed—as schematically indicated by the arrows marked as “C”—to inlet 102.

The sequential circulation of water, as a heat exchange medium, from cavity 75, radiator 110 and tank 100 allows greater rates of production of condensate. In this embodiment, the water is contained within a sealed system, in that the circulation is in a closed loop. In other embodiments, use is made of partially closed loop systems or open loop systems.

With the addition of the external heat exchanger, unit 81 is able to provide greater volumes of distilled water than would otherwise be the case. Under typical domestic operating conditions, it has been found that unit 81 provides about 2.25 to 2.5 litres of water an hour.

In this embodiment, the pump operates continuously while unit 81 is in operation. When power is disconnected from unit 81, the pump not only ceases to operate, but allows a backflow into tank 100. As tank 100 is disposed at the base of unit 81, it eventuates that, once power is disconnected, that substantially all of the water within the closed loop heat external heat exchange system is returned to tank 100. Particularly, the water between outlet 101 and end 77 will siphon back into tank 100, while the water between pipe 72 and inlet 102 will drain into tank 100 under the influence of gravity. Accordingly, tank 100 includes about 20 litres of headroom during normal operation to ensure it has sufficient capacity to contain all the water within the closed loop system. This feature is advantageous as it facilitates maintenance of unit 81, and because it reduces the risk of corrosion of components, even during periods of non-use.

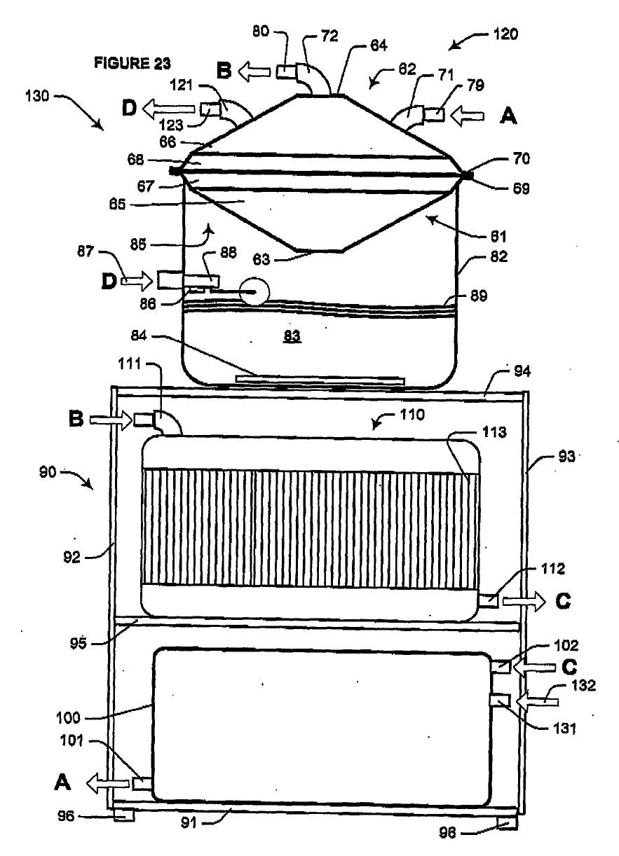

An alternative heat exchanger 120 for a partially closed loop external heat exchange system is illustrated in FIG. 22 and FIG. 23, where corresponding features are denoted by corresponding reference numerals. Turning first to FIG. 22, it will be noted that heat exchanger 120 is similar to exchanger 60, with the addition of another outlet pipe 121. This pipe extends between an inner end 122 that is disposed within cavity 75, to a second reduced diameter and 123 that is disposed external to cavity 75. End 122 is disposed substantially level with lips 69 and 70 and intermediate ends 77 and 78.

As shown in FIG. 23, heat exchanger 120 is mounted to a distillation unit 130 similarly to the mounting of heat exchanger 60 to unit 81 in FIG. 21. Again, it will be appreciated that the collector has been omitted from FIG. 23 for the sake of clarity. In use, a collected is employed below zone 63 for collecting the condensate, retaining a quantity of the condensate, and for progressing the remainder from urn 82.

In this embodiment, inlet 86 of urn 82 is connected—as schematically indicated by the arrows marked as “D”—to pipe 121. Additionally, tank 100 includes an additional inlet 131 that is disposed toward the top of the tank, but below inlet 102, and which is connected to a mains water supply (not shown). Tank 100 also includes an internal float valve (not shown) similar to valve 88. The water from the mains water supply progresses in the direction of arrow 132 toward inlet 131 under the influence of the mains water pressure. The internal float valve is designed for operation at the temperatures and pressures involved, and allows the mains water to flow through inlet 131 and replenish the water within the tank to the required level. The water level within tank 100 falls during normal operation of unit 130. Once this has occurred to a sufficient extent, the valve within tank 100 allows the water to be replenished with further water from the mains water supply.

Similarly to the FIG. 21 embodiment, the pump within tank 100 forces water into cavity 75 via end 77 of pipe 71. As this occurs, the water already contained within the cavity is displaced. However, in this embodiment, the water is displaced through pipe 72 and selectively through pipe 121. The water flows through pipe 121, and inlet 86, in the event that valve 88 is open—that is, in the event that water level 89 is below a predetermined level. As the water that passes through inlet 86 has come from cavity 75, it is at a high temperature relative to the mains supply due to the absorption of energy from the surface 61. Accordingly, it will take less energy from element 84 to have water 83 heated sufficiently to be converted to water vapour.

In this embodiment, valve 88 is subject to the water pressures generated by the pump in tank 100, as opposed to mains water pressure. Accordingly, it is not unusual for the specific valve 88 in this embodiment to be different from the specific valve used in the FIG. 21 embodiment.

In both the FIGS. 21 and 23 embodiments, radiator 110 is disposed intermediate tank 100 and the respective heat exchanger 60 and 120 to allow the self-draining functionality referred to above, as well as ensuring that only a single pump is required. However, in other embodiments, the radiator is disposed on a level with, or above, the respective heat exchanger. In further embodiments, the radiator is disposed below the tank.

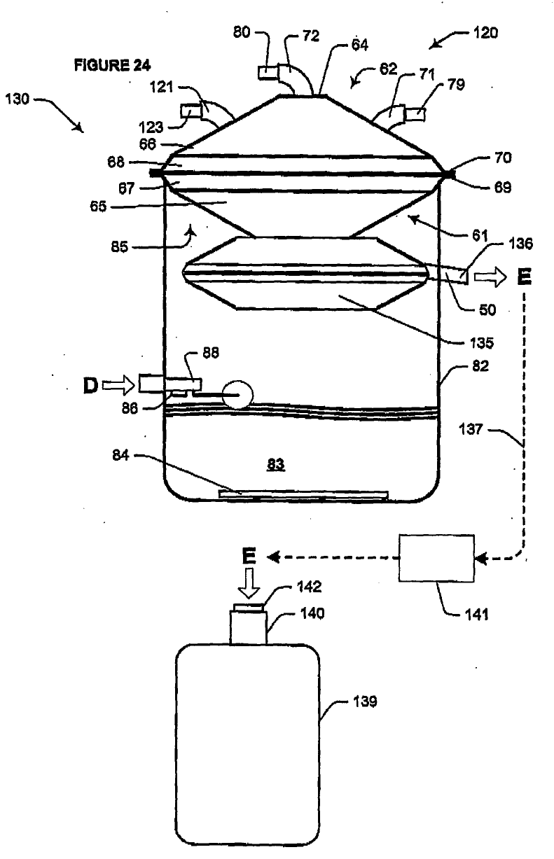

Unit 130 is also illustrated in FIG. 24, where specifically shown is a collector 135 similar to the collector of FIG. 15. Collector 135 includes an aperture 49 (not shown) and a stainless steel outlet pipe 50 that extend from the outlet, trough urn 82 and which terminates at a free end 136 that is external to the urn. As described above, collector 135, in use, retains a predetermined volume of condensate. Once that volume is exceeded—in that the level of condensate within the collector rises to aperture 49—the condensate progresses along pipe 50 to be removed from collector 135 and urn 82.

A conduit 137 (carrying a flow of condensate represented by arrows “E” in the drawing) connects end 136 of pipe 50 to an external container 139. Container 139 includes an upper spout 140 through which the condensate enters the container. In this embodiment container 139 is disposed adjacent to urn 82 with spout 140 being disposed just below end 136 to ensure a slight gravitational feed of the condensate. In other embodiments spout 140 is dispose below collector 135, while in further embodiments, opening 140 is disposed well below end 136.

In this embodiment, conduit 137 is flexible 4 mm internal diameter surgical grade silicon tube. However, in other embodiments alternative conduits are used, such as more rigid metal conduits, or other flexible conduits, whether of the same or a different internal diameter.

In this embodiment, container 139 is a polycarbonate bottle having a capacity of about 15 litres and which is commonly used with a water dispenser and/or chiller such as that often found in office and domestic installations for providing filtered water. In other embodiments, alternative containers 139 are used.

Disposed between end 136 and spout 140 is an active carbon filter 141. In other embodiments, filter 141 is omitted.

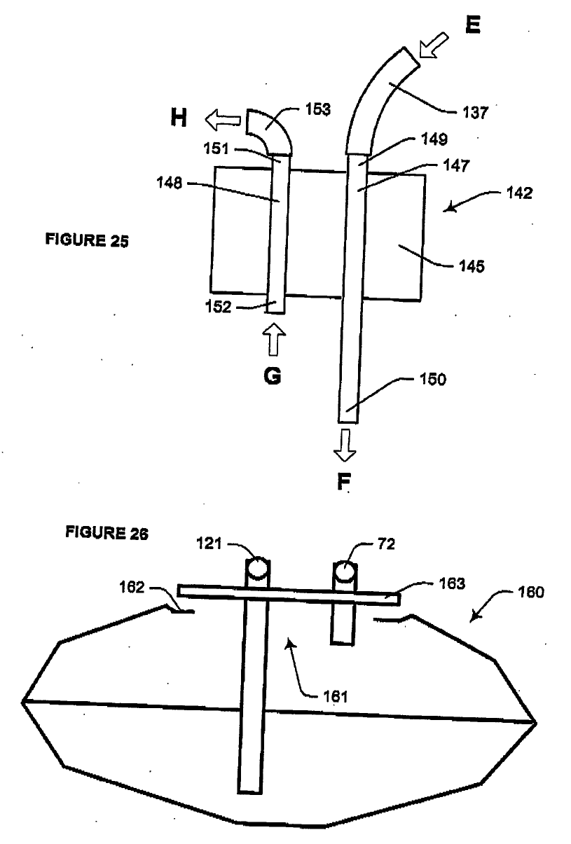

The connection between conduit 137 and spout 140 is affected by an adaptor 142, as best shown in FIG. 25 where corresponding features are denoted by corresponding reference numerals. The adaptor includes a soft substantially cylindrical plastics body 145 that is selectively sealingly mounted into spout 140. The body includes two substantially parallel and axially extending passages that sealingly receive respective rigid plastics tubes 147 and 148. Tube 147 ends between an outer end 149 that is sealingly engaged with conduit 137, and an inner end 150. Tube 148 extends between an outer end 151 and an inner end 152 that is disposed above end 150. End 151 is connected to a conduit 153 that is similar to conduit 137, and which leads to a container like container 139.

In use, the condensate progressing along conduit 137 travels in the direction of arrow E, enters end 149 of tube 147, and emerges from end 150 of that tube in the direction of arrow F. As body 145 is within spout 140, the condensate is progressed through spout 140 and into container 139. As container 139 fills, it will eventually reach the point where the condensate (typically water) will reach end 152. The height differential between end 136 and spout 140 will allow the condensate to be progressed upwardly through tube 148 in the direction of arrow G. As this continues, the condensate will progress past end 151 and into conduit 153. The other end of conduit 153 (not shown) is connected to end 149 of a tube 147 a like adaptor that is disposed within a flanker container. This arrangement is cascaded, as required, and based upon a gravity fed system. That is, while use is made of siphoning to commence filing the second or further containers, ultimately no active pumping of the condensate is required. If a large number of containers are used in series—as opposed to being disposed in parallel—there is a need to take care that the height differential between aperture 49 and spout 140 is sufficient to overcome the resistance of the conduits and tubes. It has been found that a head of water of about 2 litres is sufficient to allow several like containers 139 to be cascaded.

The containers are progressively filled and are available for use as required. It is a relatively quick and simple operation to remove an adaptor 142 from a full container, and have it placed in the spout of an empty container to continue the process. That is, it is not necessary to halt unit 130 while undertaking this operation.

The final container in the sequence has conduit 153 vented to atmosphere to prevent a build up of pressure.

The filled container is then able to be dispensed, as required. In those embodiments where container 139 is a dispensing bottle, it is available for installation within the dispenser or chiller/refrigeration unit.

The distillation units of the embodiments make use of stainless steel, and in particular 316 grade stainless steel, as an additional means for providing a high quality condensate. This is important not only for scientific and industrial application, but also in domestic and other applications where the condensate is intended for human consumption. Preferably, all surfaces contacted by the condensate, from the condensation surface on, are stainless steel or other food grade materials. Stainless steel is particularly preferred due to its corrosion resistance, ease of cleaning, case of manufacture, and relative cost.

The embodiments of the invention described above provide many advantages, both in isolation and relative to the prior art distillation units. Some of these advantages have been described above, and include:
Non-pressurised distillation. It will be appreciated that there may be small pressures developed within the units of the embodiments. However, this is typically quickly vented as the seal between the container and the heat exchanger is broken. In other embodiments the container includes a safety valve for venting such pressures,
A lightweight construction, that is allowed due to the low pressure operation of the units.
Either portable or easily disassembled.
Low safety risk due to relatively low temperature and pressure operation.
Allow the distillation of a wide variety of raw water types and quality. While reference is made above to water from a public water utility, the units are also able to distil river water, dam water, seawater, filtered water, bore water, and others. It will be appreciated by a skilled addressee, with the benefit of the teaching herein, that other sources or water are also able to be used, and that the lower the quality of that water, the shorter the intervals between cleaning and maintenance of the distillation unit.
Ease of cleaning and maintenance, in that those portions of the units that are in contact with the water being distilled are able to be easily and quickly disassembled for cleaning and/or maintenance. There is no need for skilled or highly trained labour to conduct such actions, and no special cleaning tools or operations are required.
High rates of distillation for a non-pressurised unit.
The efficient use of water. Due to sealing or substantive sealing of the heat exchange to the container, all the raw water placed in the container is progressively converted to vapour and subsequently condensed at the condensation surface and then gathered in the collector. It has been found that in normal operation very little raw water volume is lost. Moreover, in those embodiments making use of a heat exchange medium, that medium is contained within a total and substantially closed circulation loop.
The efficient use of water. Some embodiments in particular make use of the heated exchange medium as a source of raw water for the subsequent distillation. This allows reclamation of some of the energy that would have otherwise been dissipated in the external heat exchanger.
The heat exchanger is adapted for operation with a wide range of containers due to the conical or frusto-conical shape of the condensation surface.
A self-draining arrangement for an external heat exchanger.

The portable embodiments are able to be disassembled and the individual components nested within each other to minimise packaging volumed.

The inventors have also developed other embodiments of the invention that are disclosed in Australian provisional patent application numbers 2002952560 filed 8 Nov. 2002, 2003900340 filed 28 Jan. 2003, 2003902401 filed 19 May 2003, and 2003903947 filed 30 Jul. 2003. The disclosures within all those applications are incorporated herein by way of cross-reference.

For convenience the liquid that is condensed by the condensation surface, and which is subsequently enters the collector, is referred to as a condensate. However, it is also known as the distillate, and these terms are used interchangeably.

A heat exchanger of a further embodiment is illustrated in FIG. 26. Particularly, heat exchanger 160 includes a central upwardly opening substantially circular aperture 161 that is defined by a continuous circumferential lip 162. A stainless steel fitting 163 is configured for releasable complementary sealing abutment about its periphery with lip 162. That is, fitting 163 is configured for movement between an engaged configuration with lip 162, and a released configuration where, as shown, fitting 163 is spaced apart from the lip. It will be appreciated by those skilled in the art that, during use, the fitting is maintained in the engaged configuration.

Fitting 163 is secured to lip 162 of exchanger 160 by six equally circumferentially spaced bolts (not shown). In other embodiments, use is ma of other fastening means, be they equally circumferentially spaced or otherwise. In some embodiments, a gasket or other sealant is used to facilitate a sealing engagement between the periphery of fitting 163 and lip 162.

Fitting 163 supports both inlet pipe 121 and outlet pipe 72.

The removable nature of fitting 162 facilitates cleaning of the interior surface of exchanger 160. This is particularly advantageous in those embodiments where the heat exchange medium contains contaminants that are deposited within the exchanger.

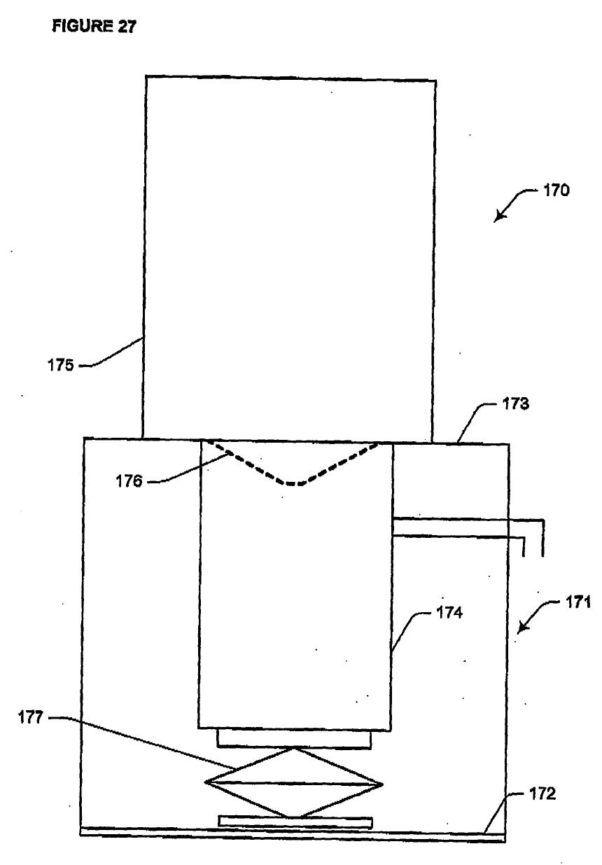

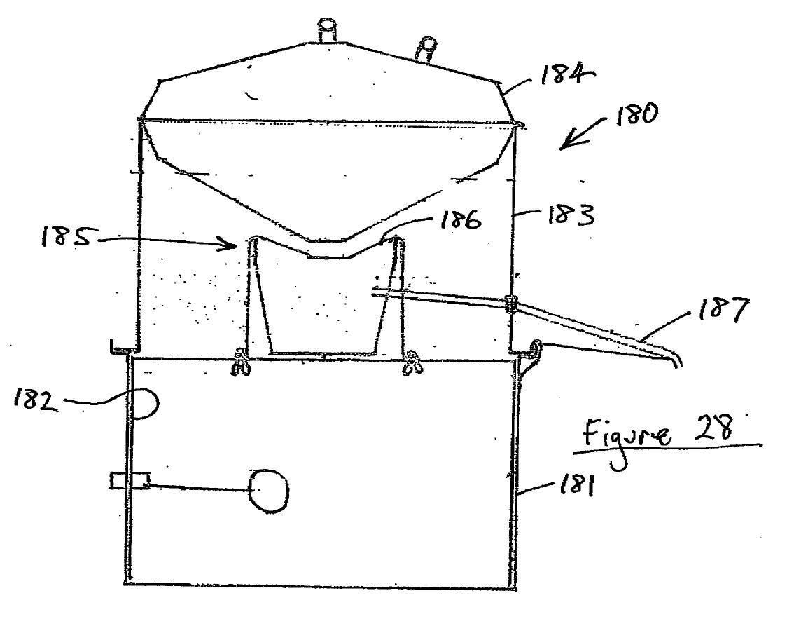

A further embodiment of the invention, in the form of a distillation unit 170, is illustrated in FIG. 27. Unit 170 is intended for use in workshops or other relatively open areas. Particularly, the unit includes a storage bench 171 having a lower shelf 172 and an upper shelf 173. An urn 174 is mounted on shelf 172 and houses a collector (not shown), similarly to the urns described above. A heat exchanger, in the form of a 200 litre drum 175 is mounted to shelf 173 and includes a base 176 that is formed frusto-conically to provide a condensation surface similarly to the respective surfaces in the above described embodiments. Base 176 extends downwardly through an aperture (not shown) in shelf 173 and into urn 174. The urn is moved manually into and out of engagement with base 176 by a height adjustment mechanism in the form of a mechanical jack 177. This facilitates cleaning of the urn, as required.

Due to the large volume of water contained within drum 175, and its large surface are it is possible to operate urn 174 continuously. The rate of production of condensate is approximately equal to that of the unit of FIG. 23, which is about 60 liters/day. It has been found that at ambient temperatures of about 25° that the temperature of the water contained within the drum does not rise above about 45° to 50°. In some embodiments, drum 175 is provided with a tap or other outlet for allowing access to heated water within the drum.

A further embodiment of the invention, in the form of a distillation unit 180, is illustrated in FIG. 28. This embodiment is portable, and includes components that are of different radius, to allow the nesting of those components within each other when not in use. This minimises the packing volume of the unit for ease of transportation. Unit 180 includes a container 181, an anti re-boil stand 182, a collar 183, a heat exchanger 184, a collector 185, a sealed lid 186 for the collector, and an outlet pipe 187. Container 181, stand 182, collar 183, and collector 184 all have different diameters and are able to be sequentially nested one within the other.

Stand 182 includes a plurality of holes (not shown) for fisher preventing inadvertent or unintended progress of the water from container 181 into collector 185, without that water having first being evaporated. This additional protection is particularly advantageous in those embodiments where the unit is subject to movement during its use. For example, when applied to motor homes, sea craft—such as recreational boats, fishing boats, and other watercraft—caravans, aircraft, or the like.

Although the invention has been described with reference to specific examples it will be appreciated by those skilled in the art that it may be embodied in many other forms. For example, while the described embodiments have been primarily directed to domestic and low volume use, other embodiments are directed to the distillation of water for medical and scientific environments.

1. A distillation unit including:
a container for receiving a ft liquid wherein the liquid is evaporated to form a liquid vapour, the container having an upwardly facing opening defined by a peripheral edge;
a heat exchanger for engaging the edge and extending across at least substantially all the opening, the exchanger having a downwardly facing condensation surface both for condensing the liquid vapour that contacts that surface and for directing the condensate inwardly from the edge to a collection zone; and
a collector being disposed within the container for receiving the condensate.

2. A unit according to claim 1 wherein the condensation surface is inclined inwardly from at least some of the edge.

3. A unit according to claim 2 wherein the condensation surface is inclined inwardly from substantially all of the edge and termites at the collection zone.

4. A unit according to claim 3 wherein the collection zone is centrally disposed and the condensation surface is conical.

5. A unit according to claim 1 wherein the downwardly facing condensation surface is inclined with respect to the horizontal by between 10° and 50°.

6. A unit according to claim 1 wherein the condensation surface is inclined with respect to the horizontal by between 15° and 30°.

7. A unit according to claim 6 wherein the condensation surface is inclined with respect to the horizontal by between 20° and 30°.

8. A unit according to claim 1 wherein the exchanger engages with the edge to substantially seal the opening.

9. A unit according to claim 1 wherein the collection zone is centrally disposed with respect to the condensation surface.

10. A unit according to claim 1 wherein the heat exchanger includes an exchanger body having an outer surface of which at least a portion defines the collection surface and an inner surface for engaging with a heat exchanging fluid.

11. A unit according to claim 1 wherein the container includes a container base, and at least one container sidewall extending upwardly from the container base and terminating in the edge, and wherein the collector includes a collector base, and at least one collector sidewall extending upwardly from the collector base for defining the collector opening.

12. A unit according to claim 11 wherein the collector base is spaced apart from the container base.

13. A unit according to claim 1 wherein the collector includes a collector opening through which the condensate enters the collector.

14. A unit according to claim 1 wherein the collector includes a collector body having a lid in which the collector opening is formed.

15. A unit according to claim 1 wherein the collector includes a filter for filtering the condensate that enters the collector.

16. A unit according to claim 1 wherein the collector, in use, retains at least about 0.5 litres of condensate.

17. A unit according to claim 1 wherein the first liquid is metered into the container.

18. A unit according to claim 17 wherein the container includes a valve for metering the first liquid into the container, wherein the valve connects the container with a source of the liquid.

19. A unit according to claim 18 wherein the valve is a float valve that is responsive to the level of the first liquid within the container forming the first fluid.

20. A distillation unit including:
a base unit having a base, at least one sidewall extending upwardly from the base and a top for collectively defining a storage space;
a container disposed on or above the top for receiving a first liquid that is evaporated to form a liquid vapour;
a first heat exchanger having:
(a) a condensation surface both for condensing the liquid vapour that contacts that surface and for directing the condensate to a collection zone; and
(b) a cavity for containing a heat exchange medium that draws heat from the condensation surface;
a collector being disposed within the container for receiving the condensate;
an outlet that extends from the collector for allowing the condensate to progress from the container; and
a second heat exchanger disposed within the storage space for cooling the heat exchange medium.
